(19) United States
(12) Patent Application Publication
(10) Pub. No.: US 2011/0299501 A1
(43) Pub. Date: Dec. 8, 2011

(54) Mobility in IMS based Home Node B

(76) Inventors: Ralf Keller, Wurselen (DE); Magnus Hallenstål, Taby (SE); Magnus Olsson, Stockholm (SE)

(21) Appl. No.: 13/143,771

(22) PCT Filed: Jan. 8, 2010
(86) PCT No.: PCT/EP10/50153

§ 371 Date: Aug. 26, 2011

Related U.S. Application Data
(60) Provisional application No. 61/143,212, filed on Jan. 8, 2009.

(51) Int. Cl. H04W 36/00

(52) U.S. Cl. 370/331

(57) ABSTRACT

The invention relates to a method for handing over an IP multimedia Subsystem, IMS, anchored session of a mobile device (100) from a Home Node B (200) of a mobile telecommunications network to another session control node (300) of said mobile telecommunications network. The mobile device (100) is circuit switched attached to said Home Node B and an interworking function unit (500) is provided enabling a connection between a circuit switched leg of the session to the Home Node B (200) and a packet switched leg of the session between the Home Node B (200) and the IMS, wherein said circuit switched leg is identified using a transaction identifier, wherein a handover request message to the interworking function unit is extended to include the transaction identifier in the message from the Home Node B or Home Node B gateway to the interworking function unit.

The present invention relates to a method for handing over an IP multimedia subsystem anchored session of a mobile device from a Home Node B to another session control node. The invention furthermore relates to an interworking function unit enabling a connection between a circuit switched leg of the session to the Home Node B and a packet switched leg of the session between the Home Node B and the IMS, to a Home Node B and a Home Node B gateway.

### BACKGROUND

Mobile networks are currently evolving from pure circuit switched (CS) networks towards IP based networks, and by that integrate into IP based infrastructures that are also used for the Internet, the World Wide Web and the datacom industry.

With this trend mobile networks closely follow the evolution steps of the wireline networks, where VoIP via DSL access or via WLAN access is existing technology today.

Mobile operators that install IMS (IP Multimedia Subsystem) networks and offer IMS services want to make these services available also to GSM/WCDMA subscribers. Hereto, calls from and to this group of GSM/WCDMA subscribers are routed through the IMS network in order for the IMS service engine to execute the call and call related services. This concept is called IMS Centralized Services (ICS). The IMS centralized Services work item in 3GPP targets at using the CS access for access to IMS services, see 3GPP TS 23.292, and is complemented by IMS Service Continuity, see 3GPP TS 23.237.

In parallel to the ICS trend the packet core is evolving (Evolved Packet Core, EPC) as part of the Evolved Packet System (EPS), supporting eUTRAN as new radio access network. As part of this discussion, work on single radio voice call continuity (SR-VCC) has been specified in 3GPP SA2 (see 3GPP TS 23.216), enabling inter domain Handover (HO) of an IMS voice call from Packet Switched (PS) domain to Circuit Switched (CS). SR-VCC can be combined with ICS for an IMS centralized solution supporting also SR-VCC from eUTRAN/PS UTRAN to CS UTRAN/GERAN.

Now the industry is aiming towards so called Home (e) Node Bs (HNB or HeNB) for providing radio access to a mobile device. Herein the NodeB or eNodeB is installed in customer premises (homes or offices) such that mobile devices can operate in-door under excellent coverage (this is of particular interest for areas with bad in-door coverage).

In a basic deployment scenario, HNBs are connected to a HNB Gateway (HNGW), which in turn is connected to the CS and PS core network like an RNC (Radio Network Controller), namely using the lu-cs and lu-ps reference points, respectively.

The Femto Forum and now also in 3GPP another deployment scenario is discussed: IMS based HNB. Here the HNGW or the HNB support IMS reference points towards the IMS core.

However, this means that the call routed over the Home Node B gateway may not be routed via a mobile switching center, but directly via the IMS. When the user of the mobile device now moves away from the zone covered by the Home Node B, the call and any related session has to be handed over to the next call/session control node, which may be an MSC. If a session is initiated for the handed over call or if an existing session has to be handed over, the call and the corresponding session have to be identified.

One solution discussed has the problem that it requires an interworking function unit (IWF), which has full MSC (mobile switching center) functionality, but details are lacking on how to provide services to the mobile device. Furthermore, it is unclear how mid-call services, such as the holding of a call, a three-party conference call or an explicit call transfer should be handled.

### SUMMARY

Accordingly, a need exists to provide a possibility to identify an IMS anchored session of a mobile device during and after a handover from a Home Node B to another session control node, such as an MSC.

This need is met by the features of the independent claims. In the dependent claims preferred embodiments of the invention are described.

According to a first aspect of the invention, a method for handing over an IP multimedia Subsystem (IMS) anchored session of a mobile device from a Home Node B of a mobile telecommunications network to another session control node of said mobile telecommunications network is provided. The mobile device is circuit switched attached to the Home Node B and an interworking function unit (IWF) is provided enabling a connection between a circuit switched leg of the session to the Home Node B and a packet switched leg of the session between the Home Node B and the IMS. The circuit switched leg is identified using a transaction identifier. According to the invention, the interworking function unit receives a handover request message and this handover request message includes said transaction identifier and the interworking function unit forwards the received handover request message to a service centralization and continuity application server (SCC AS) of the IMS. A basic concept of the invention is to solve the problem by defining how the transaction identifiers are handled in the interaction between the Home Node B or the Home Node B gateway and the IWF. According to the invention, the handover request message is extended to include the transaction identifier from the Home Node B gateway or the Home Node B to the interworking function unit. The circuit switched and packet switched leg are not necessarily terminated at the HNB but the CS leg may extend beyond it to the IWF if the IWF is provided outside the HNB. The CS leg leads to the HNB but possibly further and the PS leg leads towards the IMS while the interconnection of both legs may be provided in different places.

According to a preferred embodiment, when the session has been handed over to the other session control node, e.g. a MSC, the interworking function unit receives any signalling involving said transaction identifier from said other session control node. This means that the IWF acts as anchor MSC (and is deployed in addition to existing MSCs). In particular, the other session control node to which the call/session is handed over will forward DTAP messages to the interworking function unit. The interface is adapted to transfer signalling as it is used between MSCs in customary networks. The lu interface is adapted to transfer signalling with the radio access network.

According to a preferred embodiment of the invention, the interworking function unit uses the transaction identifier to identify a call to which said session is related and initiates any services requested. Furthermore, the lu interface may be adapted to support the exchange of transaction identifier related information. The handover request message received by the interworking function unit can be a session transfer request. Preferably, the interworking function unit initiates a handover command to the other session control node, e.g. an MSC.

According to another aspect of the invention, an interworking function unit is provided handing over the IMS anchored session of the mobile device from the Home Node B to the other session control node wherein the mobile device is circuit switched attached to said Home Node B. The interworking function unit enables the connection between the circuit switched leg of the session to the Home Node B and the packet switched leg of the session between the Home Node B and the IMS. According to the invention, the interworking function unit comprises an interface that is configured to receive a handover request message including the transaction identifier that is normally used to identify a circuit switched leg. According to one embodiment of the invention, the interface is the lu interface configured to support the exchange of transaction identifier related information. The interworking function unit may be provided in the Home Node B, in the Home Node B gateway or in the session control node to which the call is handed over or may be an independent node. Depending on the fact in which node the interworking function unit is provided the corresponding interfaces should be adapted accordingly. In one embodiment of the invention the E interface between the interworking function unit and the MSC is configured to support the exchange of transaction identifier related information.

According to another aspect of the invention, a session control unit is provided that takes over the session from the Home Node B, the session control unit comprising the interworking function unit as mentioned above. In another embodiment, the interworking function unit is incorporated into the Home Node B gateway. In still another embodiment the interworking function unit is contained in the Home Node B.

According to another aspect of the invention, a method for handing over the IMS anchored session of the mobile device from the Home Node B to the other session control node is provided wherein a handover request message is transmitted from the Home Node B or Home Node B gateway to the interworking function unit, the handover request message including the transaction identifier. Furthermore, the Home Node B or Home Node B gateway transmits a handover command to the mobile device.

### BRIEF DESCRIPTION OF THE DRAWINGS

The invention will be described in further detail below with reference to the accompanying drawings, in which

FIG. 1 shows a mobile device handover mechanism according to the prior art,

FIG. 2 shows a handover mechanism according to the invention with the IWF unit being provided separately between a Home Node B gateway and a MSC to which the session is handed over,

FIG. 3 shows a schematic embodiment of a Home Node B gateway, as it may be used in the embodiment of FIG. 2.

FIG. 4 shows another embodiment of a session handover according to the invention in which the interworking function unit is provided in the Home Node B gateway,

FIG. 5 shows an embodiment of a session handover according to the invention in which the IWF unit is provided in the MSC to which the session is handed over,

FIG. 6 shows a schematic view of the MSC of FIG. 5, and

FIG. 7 shows a schematic view of a Home Node B in which the IWF unit is incorporated.

### DETAILED DESCRIPTION

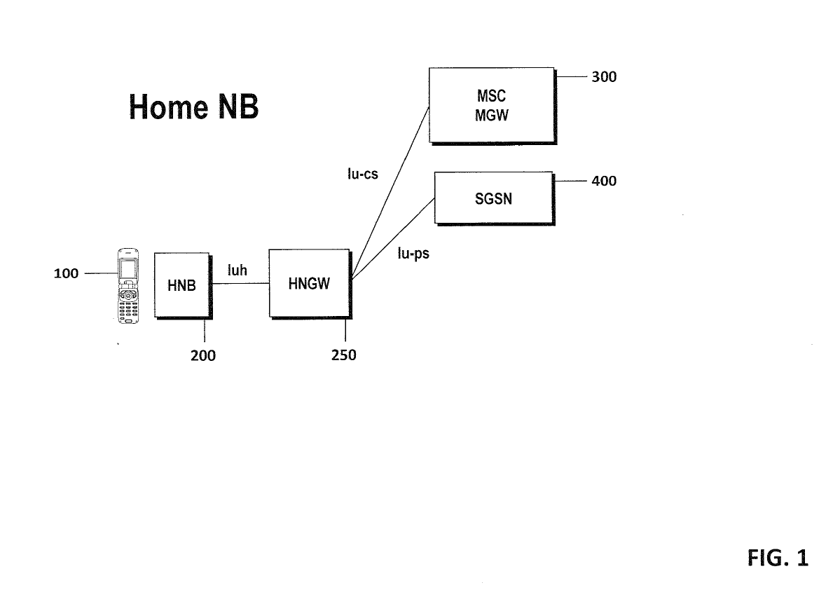

In FIG. 1 a scenario is shown in which a mobile device 100 uses a Home Node B 200 for providing a radio access. The Home Node B 200 is connected to a Home Node B gateway 250 via an luh interface which in turn is connected to the circuit switched core network like an RNC. A packet switched connection to the SGSN 400 is provided, using the lu packet switched interface, whereas a circuit switched lu interface is provided for a connection to the MSC/MGW 300. In this scenario shown in FIG. 1 existing handover mechanisms are used.

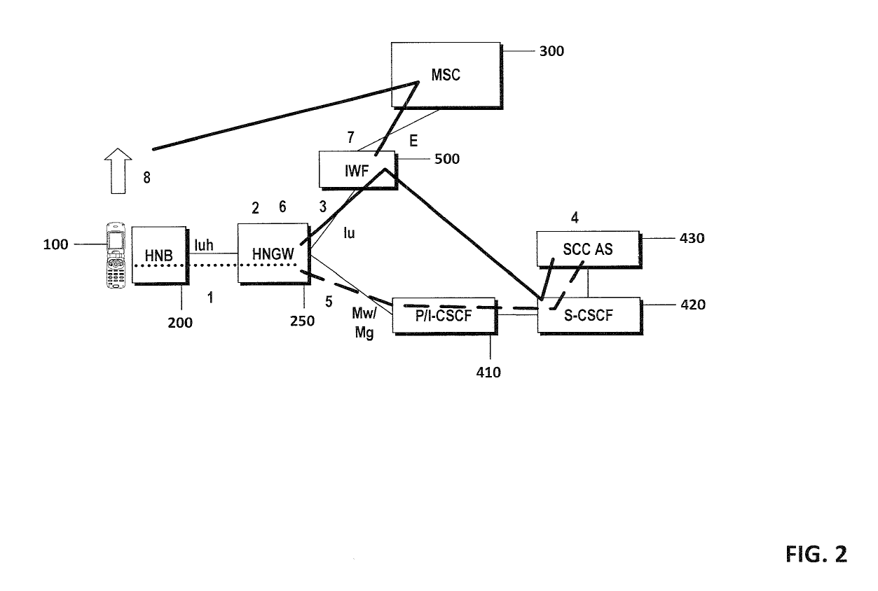

In FIG. 2 an embodiment is shown in which transaction identifiers are handled according to the invention between the Home Node B gateway and an interworking function unit that enables a connection between the circuit switched attachment of the mobile device 100 to the Home Node B gateway 250 and the packet switched connection of the Home Node B gateway 250 to the IMS. Thus, the precondition is that the mobile device 100 is circuit switched attached to the Home Node B and active. When the mobile device 100 moves away as symbolized by the arrow, the following procedure for handover from the Home Node B to another control node of the mobile telecommunications network, to which the Home Node B is also connected, is carried out.

The following numbering relates to the session steps 1 to 8 as indicated in FIG. 2.
1. The session is anchored in the IMS and a transaction identifier is assigned for any call by the mobile device 100 for originating calls and by the Home Node B gateway 250 for terminating calls to the mobile device 100. The gateway 250 connects the circuit switched call leg (dotted line) towards the mobile device with the call leg towards the IMS, the dashed line showing the connection of the gateway to the proxy/interrogating call service control function (P/I-CSCF) from where the session is transmitted to the serving CSCF (S-CSCF), the S-CSCF 420 being connected to a service centralization and continuity application server 430 (SCC AS). The gateway 250 stores the transaction identifier that is either initiated by the mobile device 100 or by the media gateway 250. The transaction identifier is known to the mobile device and the Home Node B gateway and is used for identifying a call if a service for the call is invoked.
2. The Home Node B gateway 250 determines the need for a handover, e.g. based on measurement reports sent by the Home Node B. Neighbouring cells need to be configured such that the Home Node B can provide information to the mobile device on which neighbour cells to measure.
3. The Home Node B initiates a session transfer request (see 3GPP TS 23.237) towards the IWF 500 using the same transaction identifier. The IWF 500 forwards the request to the SCC AS 430. In the embodiment shown it is assumed that the SCC AS 430 is a stand alone application server, however, the invention is not limited to this case. The SCC AS functionality could also be collocated with the IWF or any other function.
4. SCC AS 430 performs session transfer
5. The dashed call leg is released
6. HNGW 250 sends handover required to IWF
7. IWF 500 initiates Inter MSC Handover command towards target MSC 300.
8. HNGW forwards handover command to the mobile device, the mobile device performing the handover to circuit switched (continuous bold line).

In this embodiment the IWF 500 acts as anchor MSC and needs to be deployed in addition to existing MSCs. Accordingly, the MSC 300, to which the call is handed over in step 8 will forward any signalling involving the transaction identifier, in particular DTAP messages to the IWF 500. The E interface is adapted to transfer signalling as it is used between MSCs in customary networks. The lu interface is adapted to transfer signalling with the radio access network.

The IWF uses the transaction identifier provided by the Home Node B gateway 250 to identify the call and to initiate any services requested. Furthermore, the lu reference point (which carries, amongst others, DTAP signalling) is extended to support the exchange of transaction identifier information. As will be shown further below, the IWF may also be included in the MSC. In this situation the lu reference point needs to be enhanced as well and the MSC is impacted by the need to handle the transaction identifiers correctly, otherwise the solution only works for terminating calls in the Home Node B and only when default numbers are assigned for transaction identifiers known by both the Home Node B gateway and the IWF unit 500.

In the embodiment shown mid-call services are supported during session transfer. To this end the mobile device 100 requires ICS capabilities, but then it is not a legacy mobile device or the IWF has enhancements to support mid-call as described in TS 23.237.

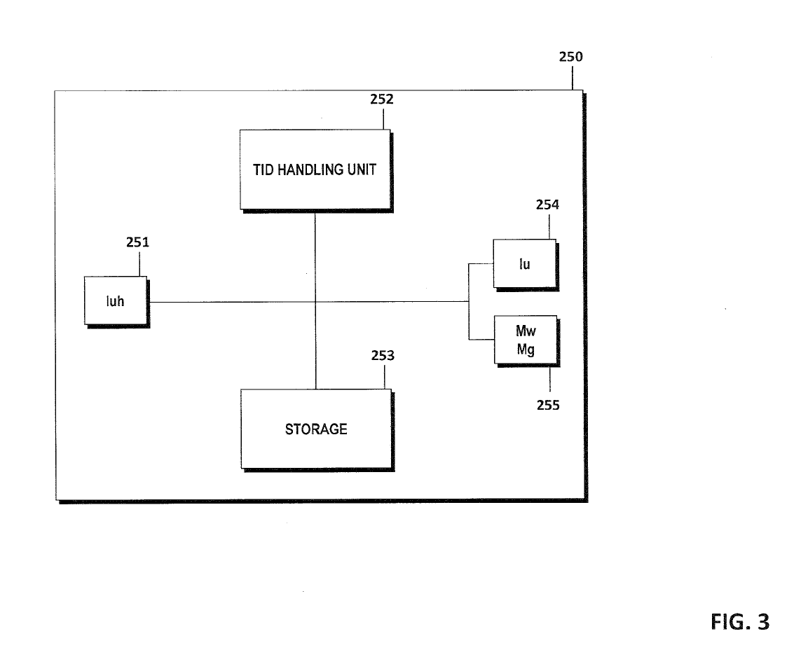

In FIG. 3 the Home Node B gateway is shown in further detail. The Home Node B gateway comprises the luh interface 251 for the connection to the Home Node B, an lu interface for the connection to the interworking function unit 500 and the Mw/Mg interface 255 for the connection to the IMS. Additionally, a transaction identifier (TID) handling unit 252 is provided that handles the session transfer request to the IWF unit 500 in such a way that the TID stored in storage unit 253 is included into the session transfer request. In the embodiment shown the different units provided in the Home Node B gateway 250 are shown as separate units and only the functions are shown that are needed for the understanding of the present invention. As known to the skilled person the Home Node B gateway comprises additional functional entities. Furthermore, it is possible that the functions carried out by the Home Node B gateway are incorporated by hardware or software or a combination of hardware and software, e.g. in a processing system of the HNB.

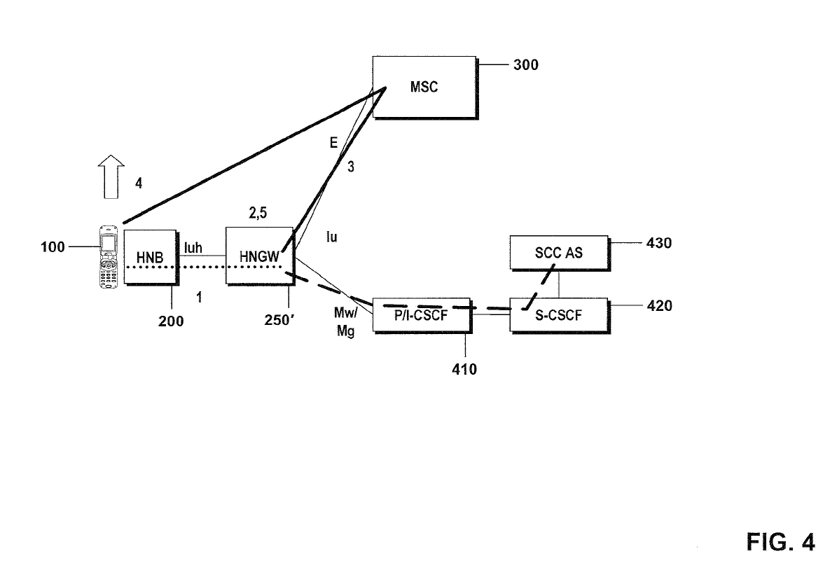

In FIG. 4 another embodiment is shown in which the interworking function unit is contained in the Home Node B gateway 250′. In this solution the Home Node B gateway with the E interface is used for the handover procedure that will be discussed below. Again the numbering of the steps relates to the Figures shown in FIG. 4.
1. The session is anchored in IMS. HNGW 250′ acts as serving MSC and connects the CS call leg (dotted) towards the mobile device 100 with the call leg towards IMS (dashed).
2. HNGW 250′ determines need for handover, based on measurement reports.
3. HNGW 250′ initiates MSC-MSC handover.
4. HNGW 250′ sends handover command to mobile device 100 and moves to target RAN (Radio Access Network).
5. HNGW 250′ connects the new call leg via the target MSC 300 (continuous) with the call leg towards IMS (dashed). HNGW 250′ stays in call as anchor MSC.

In this context, the Home Node B gateway 250′ acts as anchor MSC and the Home Node B gateway is an MSC server enhanced for ICS with SC capabilities. The embodiment shown in FIG. 4 furthermore provides support for mid-call services during and before handover.

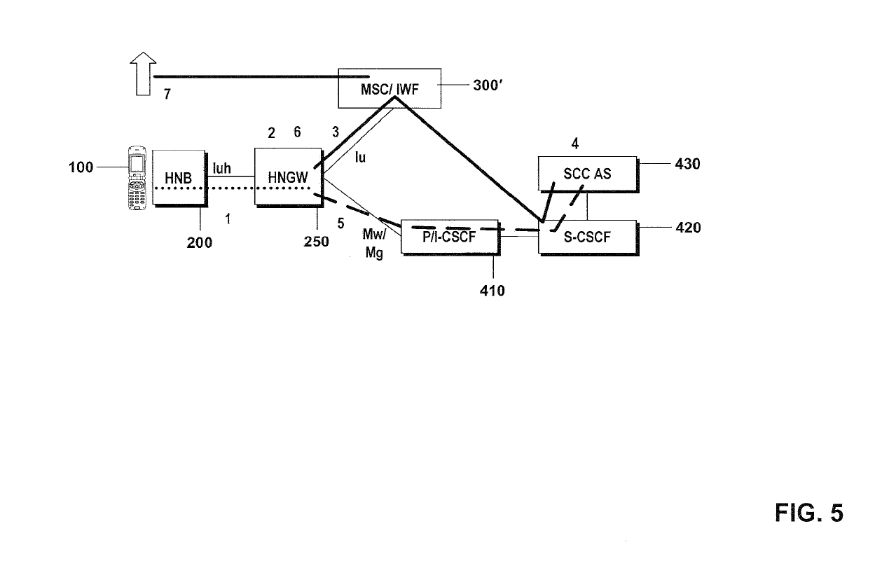

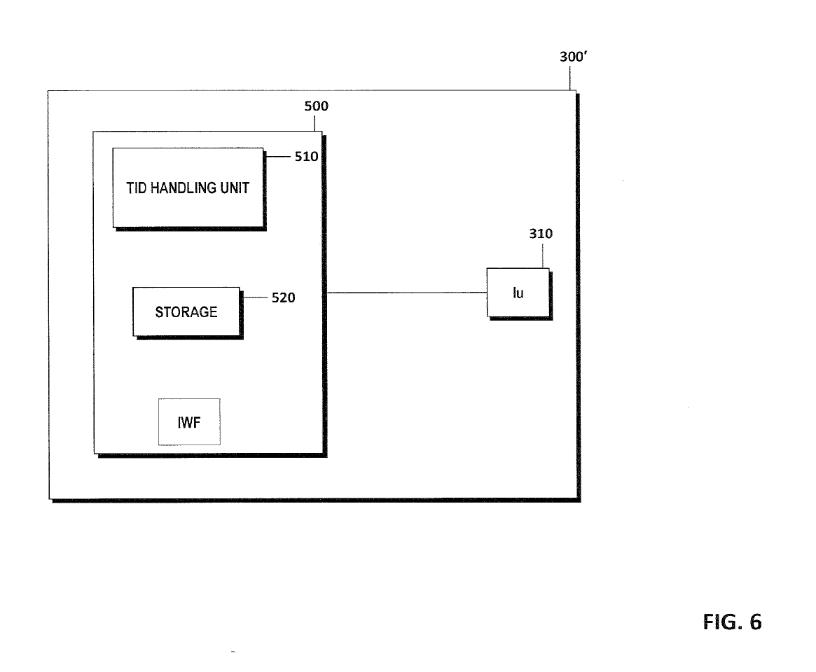

In FIG. 5 another embodiment is shown in which the IWF unit 500 is incorporated into the MSC unit as shown in FIG. 6. In this embodiment, as shown in FIG. 6 the MSC 300′ comprises the IWF unit 500 with a transaction identifier handling unit 510 and a storage unit 520 in which the transaction identifier may be stored, the lu interface 310 being provided for the connection to the MSC 300′ incorporating the IWF unit 500.

The procedure for handover from the Home Node B to the MSC of the same telecommunications network is shown in FIG. 5:
1. Session anchored in IMS. HNGW 250 connects the CS call leg (dotted) towards the mobile device 100 with the call leg towards IMS (dashed). HNGW 250 stores transaction identifier (mobile device 100 initiated or HNGW initiated). Mobile device 100 is CS attached.
2. HNGW 250 determines need for handover, based on measurement reports. The measurement reports contain information about the signal strength of radio signals received by the mobile device from antennas coupled to the Home Node B 200, and the MSC 300′, respectively.
3. HNGW 250 initiates a session transfer request towards the MSC 300′, using the same transaction identifier. MSC 300′ forwards the request to the SCC AS 430.
4. SCC AS 430 performs session transfer.
5. Dashed call leg is released.
6. HNGW send handover required to MSC.
7. HNGW forwards handover command to and mobile device 100 performs handover to CS (continuous).

The embodiment is similar to the IWF option with IWF in the MSC. However, only one logical node is used so that proprietary signalling can be used instead of external interfaces between the IWF and the MSC functionality. The MSC uses the transaction identifier provided by HNGW 250 to identify the call. The lu reference point (DTAP signaling) is extended to support the exchange of transaction identifier related information. The MSC is impacted by the need to handle the transaction identifiers correctly, otherwise the solution only works for terminating calls in the HNB. Furthermore, mid-call services are supported during session transfer. Mobile device 100 requires ICS capabilities (but then it is not a legacy UE) or MSC/IWF has enhancements to support mid-call as described in TR 23.838. The benefits of the modified lu approach are: Network Operation Mode I can be supported for HNB (i.e. Combined RA/LA and the Gs interface). Network Operation Mode or NOM is the term used in TS 23.060. In NOM I the network supports the Gs interface between the MSC and the SGSN and the Gs interface can be used to send e.g. CS paging messages to the SGSN that forwards the page towards the mobile device. In NOM II and NOM III there is no Gs interface and the MSC and SGSN page the mobile device for CS and PS services respectively. When a mobile device moves between a cell that broadcasts NOM I and a cell that broadcasts NOM II or III it has to perform RA/LA update procedures. So for an operator that has deployed support for NOM I/Gs, a HomeNB solution that can also support NOM I could decrease the idle mode signalling. Idle mobility management can be handled without HSS interaction.

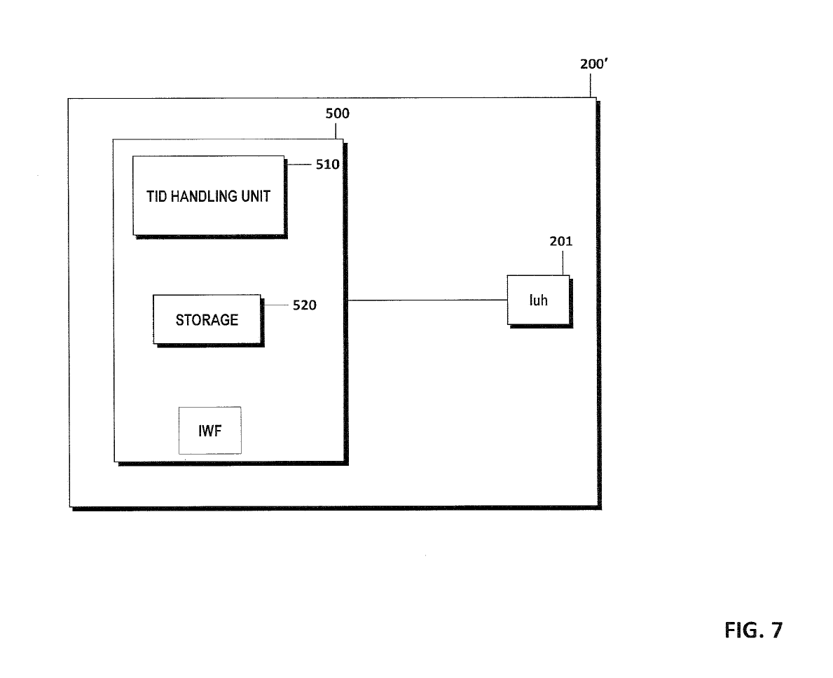

In the embodiments described above, the interworking function unit was provided in the Home Node B gateway, in the MSC to which the call is handed over or was a stand alone unit. Additionally, it is possible that the communication is directly handed from the Home Node B towards the IWF and the MSC. In this situation the IWF can be in the Home Node B, the Home Node B gateway or in the MSC. In FIG. 7 a Home Node B 200′ is shown incorporating the IWF unit 500 with its TID handling unit 510 and the storage 520 to store the transaction identifier. The luh interface is provided for communicating with the gateway 250. A protocol exists between the Home Node B and the Home Node B gateway through which the transaction identifier is transmitted if the IWF unit is not contained in the Home Node B.

Summarizing the present invention allows handover of an IMS anchored speech session from a Home Node B to other call control nodes or session control nodes of the same telecommunications network. Furthermore, the invention allows support for mid-call services for handover from the Home Node B to the mobile communications network.

### Further Abbreviations

### 3GPP Third Generation Partnership Project

### DTAP Direct Transfer Application Part

### GERAN GSM EDGE Radio Access Network

GSM Global System for Mobile communications

### IP Internet Protocol

### MSC Mobile Switching Centre

### TS Technical Specification

(e)UTRAN (evolved) Universal Terrestrial Radio Access Network
VoIP Voice Over IP

1-13. (canceled)

14. A method for handing over an IP multimedia Subsystem, IMS, anchored session of a mobile device from a Home Node B of a mobile telecommunications network to another session control node of said mobile telecommunications network, the mobile device being circuit switched attached to said Home Node B, an interworking function unit enabling a connection between a circuit switched leg of the session to the Home Node B and a packet switched leg of the session between the Home Node B and the IMS, wherein said circuit switched leg is identified using a transaction identifier, the method comprising:
receiving, by the interworking function unit, a handover request message, said handover request message including said transaction identifier; and
forwarding, by the interworking function unit, the received handover request message to a Service Centralization and Continuity Application Server of the IMS.

15. The method according to claim 14, further comprising receiving signaling involving said transaction identifier from the other session control node after the session has been handed over.

16. The method according to claim 14, further comprising using, by the interworking function unit, the transaction identifier to identify a call to which said session is related and initiating any services requested.

17. The method according to claim 14, wherein the lu interface is extended to support the exchange of transaction identifier related information.

18. The method according to claim 14, wherein receiving the handover request message comprises receiving a session transfer request.

19. The method according to claim 14, further comprising initiating, by the interworking function unit, a handover command to the other session control node.

20. An interworking function unit configured to hand over an IP multimedia Subsystem, IMS, anchored session of a mobile device from a Home Node B of a mobile telecommunications network to another session control node of said mobile telecommunications network, the mobile device being circuit switched attached to said Home Node B, the interworking function unit comprising an interface configured to receive a handover request message including a transaction identifier, and further configured to enable a connection between a circuit switched leg of the session to the Home Node B and a packet switched leg of the session between the Home Node B and the IMS, wherein said circuit switched leg is identified using said transaction identifier.

21. The Interworking function unit according to claim 20, wherein the network interface comprises an lu interface configured to support the exchange of transaction identifier related information.

22. The interworking function unit according to claim 20, further comprising an E interface configured to support the exchange of transactions identifier related information.

23. The interworking function unit according to claim 20, wherein the interworking function unit is disposed in a session control unit taking over the session from the Home Node B in a handover mechanism.

24. The interworking function unit according to claim 20, wherein the interworking function unit is disposed in a Home Node B gateway handling the IP multimedia Subsystem, IMS, anchored session of the mobile device that is circuit switched attached to said Home Node B gateway of the mobile telecommunications network.

25. The interworking function unit according to claim 20, wherein the interworking function unit is disposed in the Home Node B.

26. A method for handing over an IP multimedia Subsystem, IMS, anchored session of a mobile device from a Home Node B of a mobile telecommunications network to another session control node of said mobile telecommunications network, the mobile device being circuit switched attached to said Home Node B, an interworking function unit enabling a connection between the circuit switched leg of the session to the Home Node B and a packet switched leg of the session between the Home Node B and the IP Multimedia Subsystem, wherein a transaction identifier identifies said circuit switched leg, the method comprising:
transmitting, by said Home Node B or a Home node B gateway to the interworking function unit, a handover request message, said handover request message including said transaction identifier; and
transmitting a handover command to the mobile device.
